(19) United States
(12) Patent Application Publication
(10) Pub. No.: US 2015/0310062 A1
(43) Pub. Date: Oct. 29, 2015

(54) EXERCISE INFORMATION SEARCHING METHOD AND EXERCISE INFORMATION SEARCHING SYSTEM

(71) Applicant: ZAN QUAN TECHNOLOGY CO., LTD, Taichung City (TW)

(72) Inventors: Kai-Li Wang, Taichung City (TW); Hsia-Hung Ou, Taichung City (TW)

(21) Appl. No.: 14/696,598

(22) Filed: Apr. 27, 2015

(30) Foreign Application Priority Data
Apr. 28, 2014 (CN) 103115124

(51) Int. Cl. G06F 17/30

(52) U.S. Cl. CPC G06F 17/30424; G06F 17/30554

(57) ABSTRACT

An exercise information searching method and an exercise information searching system are provided, including a first central processing unit, a first exercise information database connected to the first central processing unit, a second central processing unit, a second exercise information database connected to the second central processing unit, and a searching-comparing interface. The searching-comparing interface is in connection transmission in dual direction with the first exercise information database. A key word to be searched and compared is input to the searching-comparing interface displayed in the second central processing unit. The key word input to the searching-comparing interface exchanges information with the first exercise information database, so as to obtain and display a result. Therefore, an exerciser is allowed to search for suitable exercise data, as a goal of conducting exercise competition and training.

### BACKGROUND OF THE INVENTION

1. Field of the Invention

This invention relates to methods and systems for exercise information, and, more particularly, to an exercise information searching method and an exercise information searching system that search, compare and establish exercise information.

2. Description of Related Art

Exercise is good to health. People can have fun in exercise. Professional athletes, and ordinary people as well, have their own exercise preference.

Exercise is not only good to health, it can also affect people mentally, such as increasing one's confidence. Exercisers need someone as an object to be compared with. In the past, the object includes a finite number of people, such as teammates or friends only, and, as such, the training effect is very limited.

### SUMMARY OF THE INVENTION

In order to solve the problems of the prior art, the present invention provides an exercise information searching method and an exercise information searching system, including a first central processing unit, a first exercise information database connected to the first central processing unit, a second central processing unit, a second exercise information database connected to the second central processing unit, and a searching-comparing interface. The searching-comparing interface is in connection transmission in dual direction with the first exercise information database. A key word to be searched and compared is input to the searching-comparing interface displayed in the second central processing unit. The key word input to the searching-comparing interface exchanges information with the first exercise information database, so as to obtain and display a result. Therefore, a user is allowed to search for suitable exercise data, as a goal of conducting exercise competition and training.

### BRIEF DESCRIPTION OF DRAWINGS

The invention can be more fully understood by reading the following detailed description of the preferred embodiments, with reference made to the accompanying drawing, wherein:

FIG. 1 is a block diagram of a preferred embodiment according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

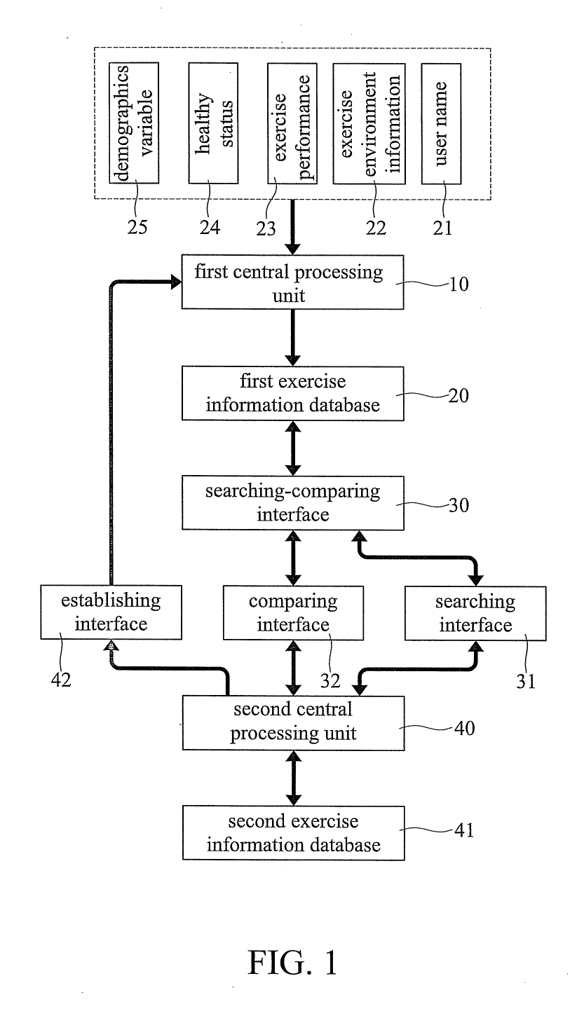

Please refer to FIG. 1, which illustrates an exercise information searching method of a preferred embodiment according to the present invention. The exercise information searching method comprises the following steps.

A, Establishing an Exercise Information Database:

A first central processing unit 10 establishes a first exercise information database 20. In an embodiment, the first exercise information database 20 contains a user name 21, exercise environment information 22, exercise performance 23, a healthy status 24, and a demographics variable 25. In an embodiment, the first central processing unit 10 is an electronic apparatus that has a compiling function, such as a server, a computer, and a laptop computer. The first central processing unit 10 provides a searching-comparing interface 30 that is provided to a second central processing unit 40 by identifying, registering, loginning, or APP downloading. In an embodiment, the second central processing unit 40 is a server, a computer, a laptop computer, a smart phone, a tablet computer, or other electronic apparatuses. The second central processing unit 40 is in connection transmission in dual direction with the first exercise information database.

B, Inputting Searching, Comparing or Establishing Data: A user is allowed to select one of a plurality sub-interfaces from the searching-comparing interface 30 displayed by the second central processing unit 40 to display a result. In an embodiment, the sub-interfaces of the searching-comparing interface 30 are a searching interface 31 or a comparing interface 32.

B1, if the searching interface 31 is selected, a key word of a specific item can be input to the searching interface 31, and the second central processing unit 40 displays exercise information searched from the first exercise information database 20;

B2, if the comparing interface 32 is selected, exercise data of himself can be input to the comparing interface 32 and compared with exercise information stored in the first exercise information database 20, and the compared information is displayed after recommendation events and matching number are determined;

B3, the second central processing unit 40 is connected to a second exercise information database 41. In an embodiment, the second exercise information database 41 stores exercise information generated by a user, and the exercise information downloaded from the first exercise information database 20. through the connection operation of the second central processing unit 40 and the second exercise information database 41, a user is allowed to take the downloaded exercise information as a goal to conduct exercise competition and training. Besides, the second central processing unit 40 is connected via an establishing interface 42 with the first exercise information database 20 that is connected to the first central processing unit 10 to conduct data connection transmission and establish the exercise information generated by the user in the first exercise information database 20. When a user selects the establishing interface 42, detailed contents of exercise information, such as a user name, exercise environment information, exercise performance, a healthy status, and a demographics variable, can be input to the establishing interface 42, and the establishing interface 42 uploads the user's exercise information to the first exercise information database 20 that is connected to the first central processing unit 10.

The above paragraphs describe an exercise information searching method and an exercise information searching system 100 of a preferred embodiment according to the present invention. The advantages of the present invention are as follows.

Professional athletes, and ordinary people as well, when using the method and system provided according to the present invention, can obtain suitable exercise data, as a goal of exercise competition and training, to achieve the exercise effect. Besides, exercise information of himself can also be established, to achieve the effects of recording and reference.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An exercise information searching method, comprising:
connecting a first central processing unit to a first exercise information database, and having a searching-comparing interface perform a connection transmission in dual direction with the first exercise information database and a second central processing unit; and
inputting a key word that is to be searched and compared to the second central processing unit displayed in the searching-comparing interface, such that the key word input to the searching-comparing interface exchanges information with the first exercise information database, and a result is obtained and displayed.

2. The exercise information searching method of claim 1, wherein the first exercise information database includes a user name, exercise environment information, exercise performance, a healthy status, and a demographics variable.

3. The exercise information searching method of claim 1, wherein the first central processing unit is a server, a computer, a laptop computer, a smart phone, or a tablet computer.

4. The exercise information searching method of claim 1, wherein the searching-comparing interface is provided to the second central processing unit by identifying, registering, loginning, or APP downloading.

5. The exercise information searching method of claim 1, wherein the second central processing unit is a computer, a laptop computer, a smart phone, a tablet computer, or a wearable electronic apparatus.

6. The exercise information searching method of claim 1, wherein the searching-comparing interface has a plurality of sub-interfaces, the sub-interfaces of the searching-comparing interface are a searching interface and a comparing interface, the searching interface acquires and displays from the first exercise information database exercise information to be searched, and the comparing interface inputs exercise data of a user, compares the exercise data with exercise data of the first exercise information database, and displays the compared information after recommendation events and matching number are determined.

7. The exercise information searching method of claim 1, wherein the second central processing unit is connected to a second exercise information database and an establishing interface, the second exercise information database stores exercise information, a user is allowed to take downloaded exercise information as a goal to conduct exercise competition and training via a connection operation of the second central processing unit and the second exercise information database, and the establishing interface inputs or establishes detailed contents of every exercise information via the second central processing unit, and transmits the detailed contents into the first exercise information database.

8. An exercise information searching system, comprising:
a first central processing unit connected to a first exercise information database; and
a second central processing unit having a searching-comparing interface, the searching-comparing interface being in connection transmission in dual direction with the first exercise information database;
wherein a key word to be searched and compared is input to the searching-comparing interface, and the key word input to the searching-comparing interface exchanges information with the first exercise information database, to obtain and display a result.

9. The exercise information searching system of claim 8, wherein the first exercise information database includes a user name, exercise environment information, exercise performance, a healthy status, and a demographics variable.

10. The exercise information searching system of claim 8, wherein the first central processing unit is a server, a computer, a laptop computer, a smart phone, or a tablet computer.

11. The exercise information searching system of claim 8, wherein the searching-comparing interface is provided to the second central processing unit by identifying, registering, loginning, or APP downloading.

12. The exercise information searching system of claim 8, wherein the second central processing unit is a computer, a laptop computer, a smart phone, a tablet computer, or a wearable electronic apparatus.

13. The exercise information searching system of claim 8, wherein the searching-comparing interface has a plurality of sub-interfaces, the sub-interfaces of the searching-comparing interface are a searching interface and a comparing interface, the searching interface acquires and displays from the first exercise information database exercise information to be searched, and the comparing interface inputs exercise data of a user, compares the exercise data with exercise data of the first exercise information database, and displays the compared information after recommendation events and matching number are determined.

14. The exercise information searching system of claim 8, wherein the second central processing unit is connected with a second exercise information database and an establishing interface, the second exercise information database stores exercise information, and the establishing interface inputs or establishes detailed contents of every exercise information via the second central processing unit, and transmits the detailed contents into the first exercise information database.
